(19) United States
(12) Patent Application Publication
(10) Pub. No.: US 2018/0187832 A1
(43) Pub. Date: Jul. 5, 2018

(54) SIDE GUIDE MOVER FOR METAL CURTAIN

(71) Applicant: RGS MILL PRODUCTS CORP., LAPORTE, IN (US)

(72) Inventors: James N. Donnelly, LaPorte, IN (US); Clarence R. CONN, JR., Uniontown, PA (US)

(21) Appl. No.: 15/856,260

(22) Filed: Dec. 28, 2017

Related U.S. Application Data
(60) Provisional application No. 62/440,538, filed on Dec. 30, 2016.

(51) Int. Cl. F16P 1/02; F27D 1/18

(52) U.S. Cl. CPC F16P 1/02; B21C 43/00; F27D 1/1808

(57) ABSTRACT

A milling apparatus for mounting and moving curtains that contain scale, water and/or other debris within a hood structure. The hood structure can form a housing that contains fixed metal curtains and/or movable metal curtains. The movable metal curtain can include a cartridge attached to the movable metal curtain. The cartridge can be attached to the movable metal curtain. The cartridge can be attached to and/or mounted on or with respect to a support, such as a support structure mounted and/or fixed with respect to the housing. A lock can be used to selectively secure the position of the cartridge with respect to the support.

### CROSS REFERENCE TO RELATED APPLICATION

This patent application claims the benefit of U.S. Provisional application, Ser. No. 62/440,538, filed on 30 Dec. 2016, and its entire disclosure is hereby incorporated by reference herein in its entirety and is made a part hereof, including but not limited to those portions which specifically appear hereinafter.

### BACKGROUND OF THE INVENTION

### Field of the Invention

This invention relates to a curtain apparatus including at least one fixed woven mesh metal curtain and/or at least one movable woven mesh metal curtain, each mounted within a corresponding slot within a top plate of a hood structure, such as a hood enclosure of an industrial descaling operation.

### Discussion of Related Art

Hood structures and hood structure assemblies are used in different industrial settings, including for descaling operations in steel mills and other industrial descaling operations.

Curtain apparatuses have been used in conventional hood structures, for example, to cover openings of descalers used in steel mills to prevent scale, slag and other undesirable debris from discharging through an opening of the hood structure or of another cover structure of the descaler. For example, U.S. Pat. Nos. 5,357,664, 5,461,763 and 5,640,747 disclose certain apparatuses that are used to contain scale, slag and other undesirable debris from discharging outside of the hood structure. The entire disclosure of each of U.S. Pat. Nos. 5,357,664, 5,461,763 and 5,640,747 is incorporated into this specification by reference thereto.

### SUMMARY OF THE INVENTION

In some embodiments of this invention, one or more movable woven mesh metal curtains of a conventional hood structure with a curtain apparatus each is removed from the conventional hood structure. In some embodiments of this invention, one or more different and improved movable curtains, such as woven mesh metal curtains, are used in a conventional hood structure.

During operation, conventional hood structures operating, for example, in a steel mill descaling facility encounter high-pressure sprays that are used to remove scale from bars, rods, strips and the like as they are processed. Within the hood structure, moisture is introduced to the stock so that the moisture vapor rises instantaneously with explosive effects, such as for removing scale. High-pressure sprays are directed at both an upper surface and a lower surface of the slab and are applied at pressures of as much as 3000 PSI. Many hot-strip mill facilities operate continuously to remove scale. With the relatively high pressures and explosive effects, scale is discharged at very high accelerations and velocities toward an opening of a descaler unit, which can include a hood structure.

One major problem associated with the high velocities of the discharged particles is that the curtain materials are often significantly bent or otherwise distorted in shape and require repair. Often, it is not possible to remove a conventional curtain structure using only the slot or other opening through which the curtain is suspended or mounted within the hood structure. Thus, it is often necessary to shut down the mill facility and remove the hood structure so that bent curtain structures can be removed or cut out, such as using cutting torches or other cutting equipment, which is costly and time-consuming.

In some embodiments of this invention, woven mesh metal curtains or other suitable curtain structures are mounted and/or suspended in a different way, particularly so that it is not necessary to install and/or remove a curtain structure through a slot or other opening of the hood structure, such as an opening of a top plate of the hood structure. With the improved curtain structures according to this invention, it is possible to more easily remove the curtain structure when it needs to be replaced, such as when it gets distorted or bent from the industrial process and the high velocity particles and other undesirable debris contacting and distorting the curtain structure.

### BRIEF DESCRIPTION OF THE DRAWINGS

The above and other features of this invention can be better understood when this specification is read in view of the drawings, wherein:

FIG. 1 shows an end view of a milling apparatus, according to one embodiment of this invention, in a closed position;

FIG. 2 shows an end view of the milling apparatus shown in FIG. 1, in an open position;

FIG. 3 shows a plan view of the milling apparatus shown in FIG. 1, in the closed position;

FIG. 4 shows a plan view of the milling apparatus shown in FIG. 1, in the open position;

FIG. 5 shows a side view of the milling apparatus shown in FIG. 1;

FIG. 6 shows a front view of a cartridge and a movable curtain, according to one embodiment of this invention;

FIG. 7 shows a front view of a cartridge, a movable curtain and a support, according to one embodiment of this invention;

FIG. 8 shows a front view of a cartridge and a support, according to one embodiment of this invention;

FIG. 9 shows a front view and a side view of a cartridge, a movable curtain and a support, according to one embodiment of this invention;

FIG. 10 shows a front view of a cartridge, a movable curtain and a support, according to one embodiment of this invention;

FIG. 11 shows a front view and a side view of a cartridge, a movable curtain and a support, according to one embodiment of this invention;

FIG. 12 shows a front view, a side view and a plan view of a base, according to one embodiment of this invention;

FIG. 13 shows a front view of supports, according to one embodiment of this invention;

FIG. 14 shows a front view, a side view and a plan view of a base, according to one embodiment of this invention;

FIG. 15 shows a front view and a side view of a cartridge, a movable curtain and a support, according to one embodiment of this invention;

FIG. 16 shows a front view, a side view and a plan view of a base, according to one embodiment of this invention;

FIG. 17 shows a front view of a cartridge, a movable curtain and a support, according to one embodiment of this invention;

FIG. 18 shows a front view, a side view and a plan view of a base, according to one embodiment of this invention; and

FIG. 19 shows a plan view of a movable side guide system, according to one embodiment of this invention.

### DETAILED DESCRIPTION OF INVENTION

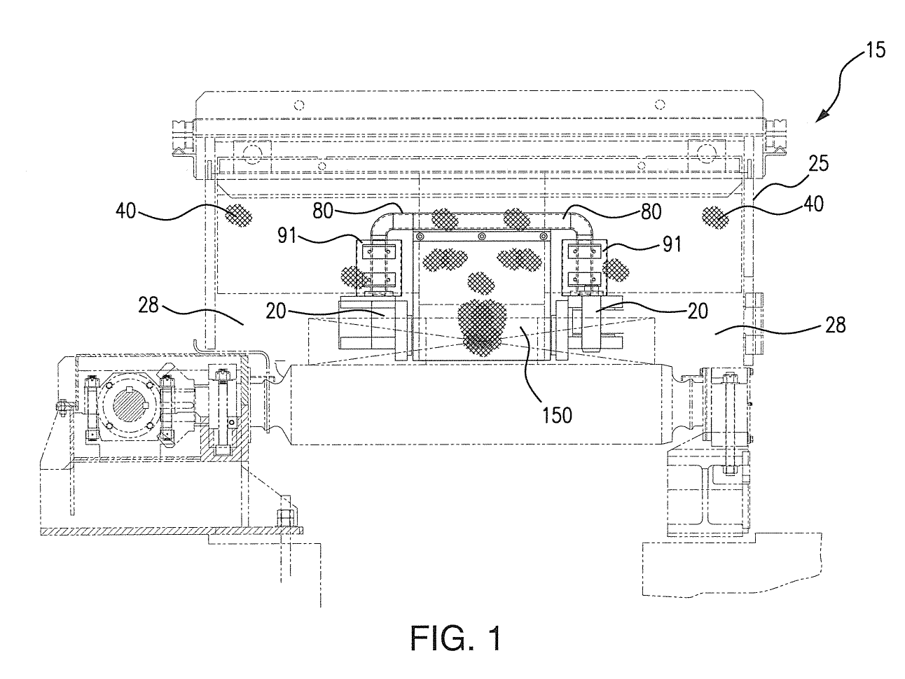

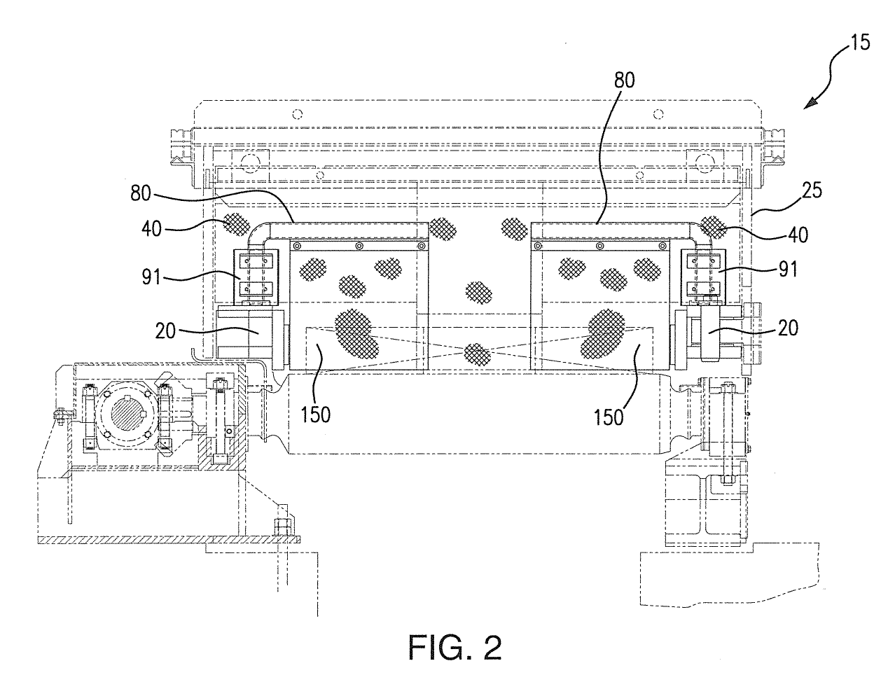

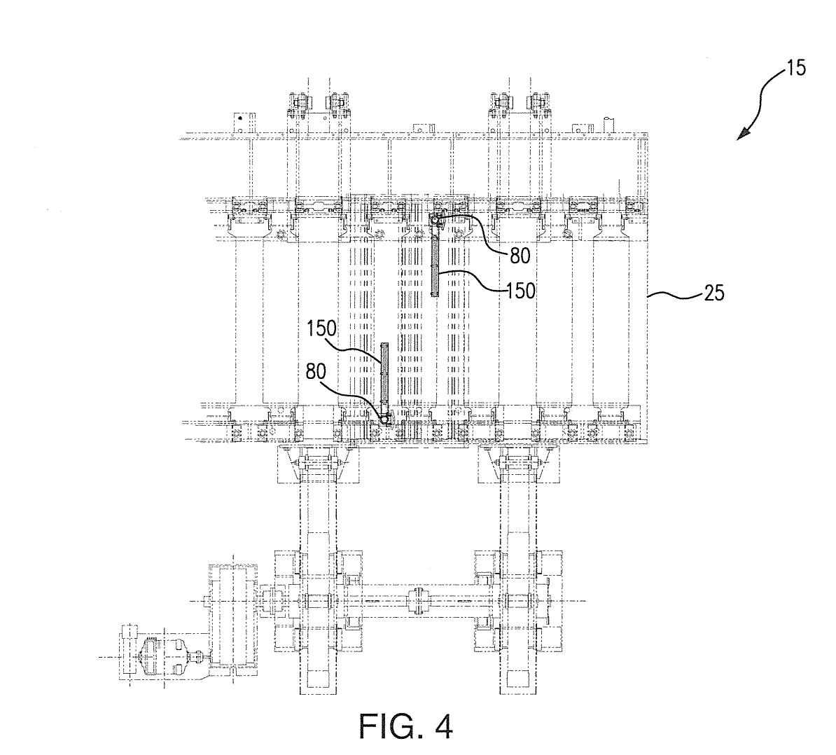

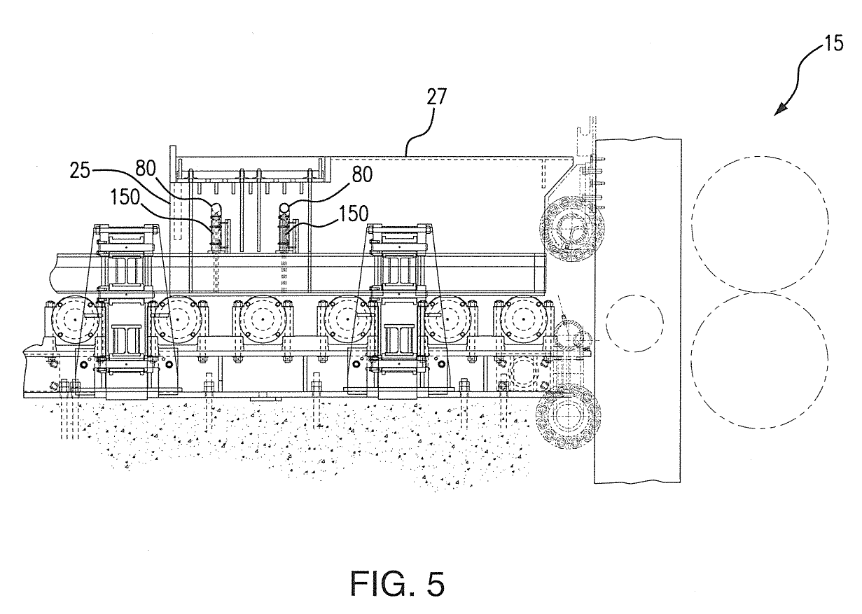

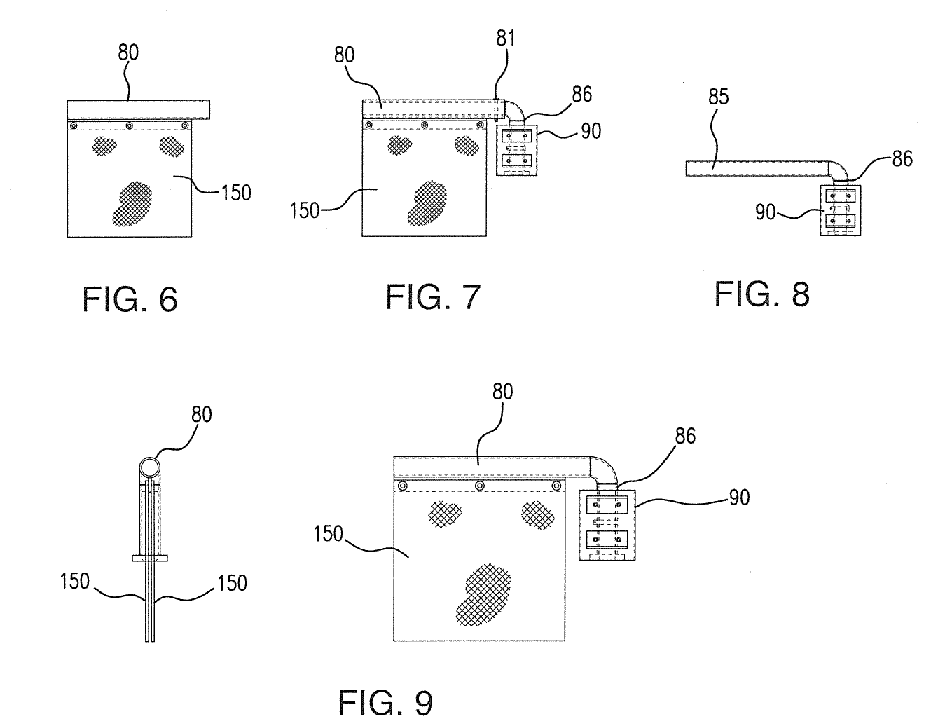

FIGS. 1-5 show different views of milling apparatus 15, according to one embodiment of this invention, in a closed position or an open position. FIG. 2 shows an end view of milling apparatus 15 in an open position. FIGS. 6-18 show views of different elements or systems of milling apparatus 15, according to different embodiments of this invention.

Milling apparatus 15 can be used in an industrial environment, such as a steel mill, a metal finishing mill and/or any other suitable manufacturing and/or industrial environment or facility. Many of the elements of this invention have the same or similar elements when compared to the disclosure of U.S. Pat. No. 5,357,664 (the 664 patent), the entire disclosure of which is incorporated into this specification by reference thereto, and which has some element reference numbers the same and some different between this invention and the disclosure of the 664 patent.

Periodically, the hood structure of milling apparatus 15 needs to be removed from the mill stand, for example, weekly or bi-weekly to check or repair descale header nozzles as well as to inspect or repair rolls and/or bearings. The removal and re-installation of the hood structure back onto the mill stand requires additional workers, such as millwrights, to make sure that one or more movable curtains 50 using plate 62 are seated properly into mover brackets 21 attached to the top of movable guide arm 20 or side guides or side guide blades. If this is not accomplished, then costly and terrible damages can occur to one or more movable curtains 50.

As shown in FIGS. 1 and 11-13 and discussed in the specification of the 664 patent, movable guide arm 20 moves between the open position and the closed position, which has similar movements according to milling apparatus 15 of this invention. In some embodiments of this invention, the relative positions between movable guide arms 20 can be changed or varied to accommodate differently sized mill stock material, such as bar stock, rod stock, slab stock or any other suitable stock material. In some embodiments of this invention, side guide blades are used in place of movable guide arms 20 and the side guide blades function to product a similar result of moving movable curtain 150 of this invention to accommodate the differently sized and/or shaped mill stock materials.

In some embodiments of this invention, the design of milling apparatus 15 includes removing one or more movable woven mesh metal curtains 50 from the descaling operations occurring within hood 25, such as disclosed in the 664 patent. In some embodiments of this invention, one or more movable woven mesh metal curtains 50 taught by the 664 patent is or are replaced by movable curtain 150 according to this invention. According to some designs of this invention, using at least one movable curtain 150 of this invention allows for easier access to install, remove and/or replace movable curtain 150 of this invention, such as when it requires maintenance or repair, for example, when it becomes overly distorted or bent too much.

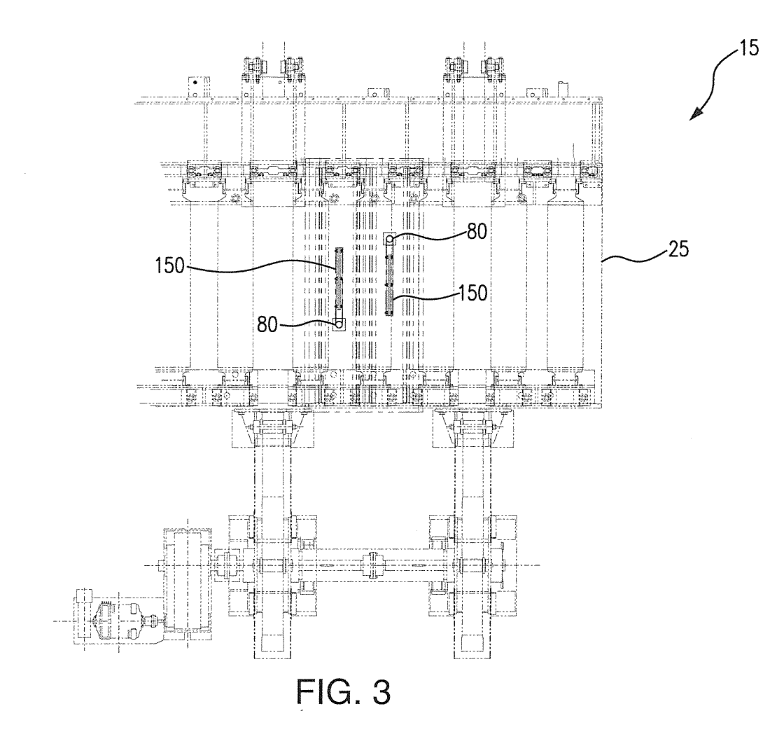

According to some embodiments of this invention, movable curtain 150 is located or positioned at a different location, relative to hood 25, than movable woven mesh metal curtain 50 as taught by the 664 patent, which is mounted within slot 29 of top plate 27, such as shown in FIGS. 1 and 6 of the 664 patent. Movable curtain 150 of this invention can be positioned for easy access to remove from the hood structure and/or repair movable curtain 150. In some embodiments of this invention, movable curtain 150 is completely contained within a housing and/or space 28 formed by hood 25. FIGS. 3-5 show this invention comprising 2 movable curtains 150. However, any other suitable number of movable curtains 150 can be used according to this invention, depending on the particular use.

In some embodiments of this invention, movable curtain 150 is attached, secured, connected and/or otherwise removably fixed in position relative to or with respect to movable arm 20 of milling apparatus 15. Thus, as each movable arm 20 moves relative to hood 25, movable curtain 150 has a following movement with respect to hood 25. The dimensions and materials of movable curtain 150 can be varied and/or selected as a function of or depending upon the particular environment within hood 25, such as a descaling operation environment. The dimensions and materials of movable curtain 150 can also be selected depending upon the amount of protection or coverage desired to prevent or minimize undesirable debris from being discharged from hood 25. In different embodiments of this invention, the dimensions of movable curtain 150 can be varied, such as in depth, height, width and/or length, to accommodate or correspond to the different mill stocks and/or other similar materials passing or routing through hood 25. FIGS. 1-5 show certain embodiments of 2 movable curtains 150 that are offset in an axial or moving direction of the mill stock moving through hood 25, however, in other embodiments of this invention, any 2 or more movable curtains 150 can be not offset with respect to each other but rather aligned or generally parallel with respect to each other. In some embodiments of this invention, movable curtain 150 can have dimensions in which at least a portion of the width and/or the length of movable curtain 150 extends across an entire width or a nearly entire width of interior space 28 of hood 25.

FIGS. 6-18 of this invention show many different embodiments of elements and/or systems used to attach, secure, connect and/or otherwise fix a relative position of movable curtain 150 with respect to movable arm 20 and/or hood 25. In some embodiments of this invention, movable curtain 150 is secured, attached, connected and/or otherwise fixed in position with respect to a support structure that is directly and/or indirectly secured, attached, connected and/or otherwise fixed in position relative to or with respect to movable arm 20 or a similarly functioning side guide blade. As used in this specification, as shown in the drawings and/or as used in the claims, the term movable arm, such as movable arm 20, is intended to be interchangeable with, relate to and have functions similar to the term side guide blade, guide blade, side guide, side blade and/or blade. In some embodiments of this invention, movable curtain 150 is welded, for example spot welded and/or plug welded, to the support structure and in other embodiments of this invention, movable curtain 150 is removably secured or attached with bolts, nuts and/or any other suitable securing device, for example, that can be secured and then unsecured.

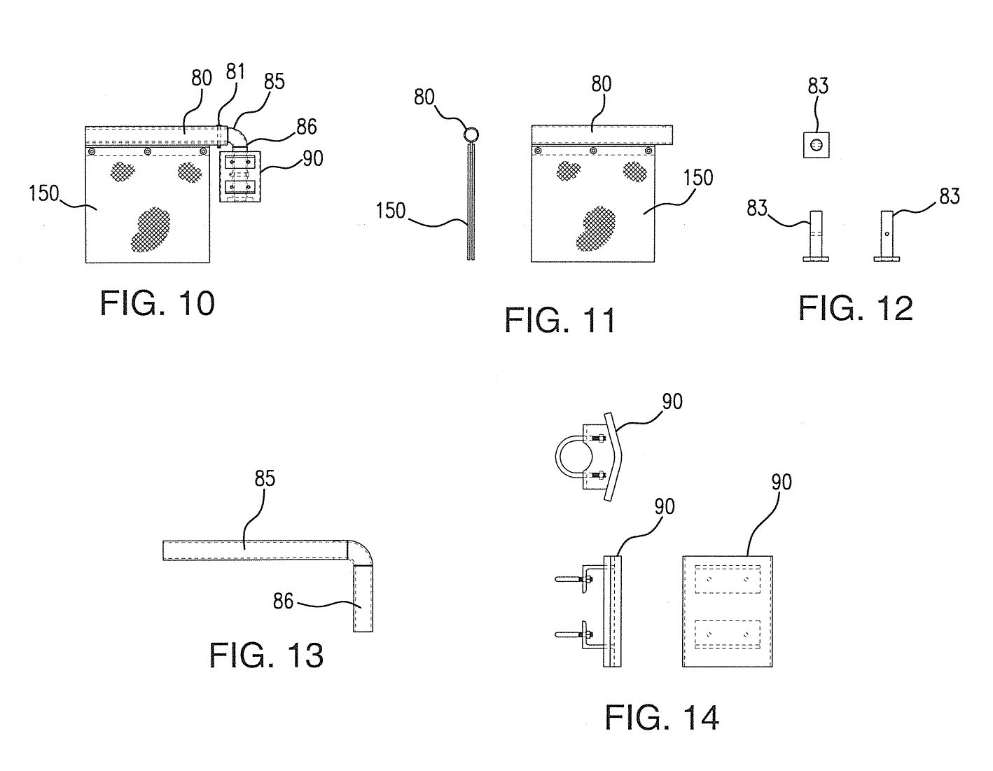

As shown in FIGS. 10 and 11, movable curtain 150 is shown having 3 welds, such as spot welds, to cartridge 80 and the welded connection is used to secure movable curtain 150 directly to cartridge 80. Cartridge 80 can be constructed of a tubular material, a pipe material and/or any other suitable material or structural element, particularly that allows cartridge 80 to move and also be lockingly secured to support 85 and/or support 86, for example, as shown in FIGS. 7-9. FIG. 10 shows lock 81 which is used to fix the relative position of cartridge 80 with respect to support 85 and/or support 86. FIG. 13 shows one embodiment of support 85 attached, connected, secured and/or otherwise fixed in position with respect to support 86. In some embodiments of this invention, support 85 is oriented in a horizontal direction and support 86 is oriented in a vertical direction, and in other embodiments of this invention, support 85 and/or support 86 can be oriented in any other suitable direction.

FIG. 12 shows base 83 according to one embodiment of this invention. Base 83 can be connected, secured and/or attached to support 86 and/or support 85 in any suitable manner. For example, in some embodiments of this invention, base 83 can be secured, attached, connected and/or otherwise fixed in position, directly and/or indirectly, with respect to movable arm 20, so that as movable arm 20 moves base 83 follows or moves along with movable arm 20. Attaching movable curtain 150 to support 85 and/or support 86, according to some embodiments of this invention, results in movable curtain 150 moving or following as movable arm 20 moves, or results in movable curtain 150 following the relative movement of movable arm 20.

FIG. 14 shows plate 90 according to some embodiments of this invention. Plate 90 can be used to shield, cover and/or protect base 83, in some embodiments of this invention. Plate 90 can have any other suitable shape and/or dimensions that can be used to protect base 83 from undesirable debris moving at relatively high velocities and contacting and/or damaging base 83.

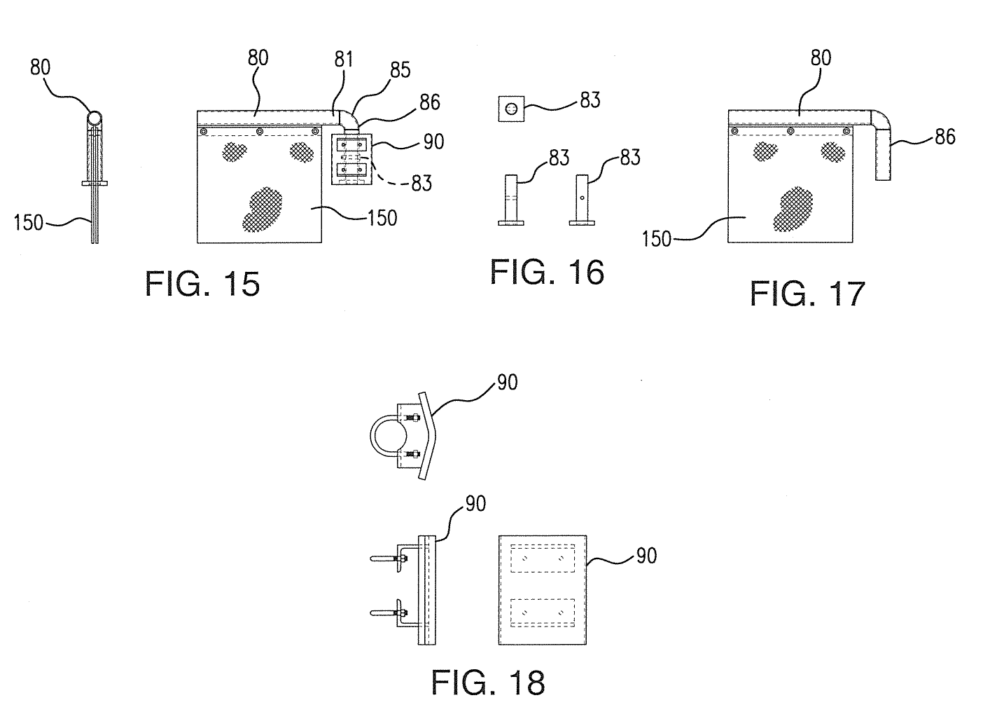

FIGS. 15-18 show another embodiment of movable curtain 150 and how it is attached with respect to cartridge 80, lock 81, base 83, support 85, support 86 and/or plate 90. Any other suitable dimensions and/or similar elements can be used to accomplish the same result of allowing movable curtain 150 to move or follow as movable arm 20 moves, for example, when milling apparatus 15 is operating.

In some embodiments of this invention, milling apparatus 15 comprises hood 25 forming a space within a housing, such as space 28 as shown in FIG. 1. In different embodiments of this invention, space 28 can have any suitable shape, size and/or dimensions, particularly that accommodates the mill stock moving through hood 25, for example. In some embodiments of this invention, one or more movable curtains 150 each is movably mounted within space 28.

As shown in FIGS. 7-11, for example, movable curtain 150 is attached, secured and/or otherwise connected directly and/or indirectly to support 85 and/or support 86. In some embodiments of this invention, movable curtain 150 is secured, connected and/or otherwise attached directly and/or indirectly to cartridge 80. In some embodiments of this invention, cartridge 80 can be locked and/or moved with respect to support 85 and/or support 86. According to some embodiments of this invention, support 85 and/or support 86 each is mounted, connected, secured, and/or otherwise attached directly and/or indirectly to hood 25 and/or its corresponding housing.

According to some embodiments of this invention, cartridge 80 comprises a tubular member, such as a pipe, a tube and/or another suitable element that can move with respect to support 85 and/or support 86. In some embodiments of this invention, lock 81 is engageable to secure or lock a position of cartridge 80 with respect to support 85 and/or support 86. Lock 81 can contact and/or interfere with movement of cartridge 80, support 85 and/or support 86, and thus fix or secure cartridge 80 with respect to support 85 and/or support 86.

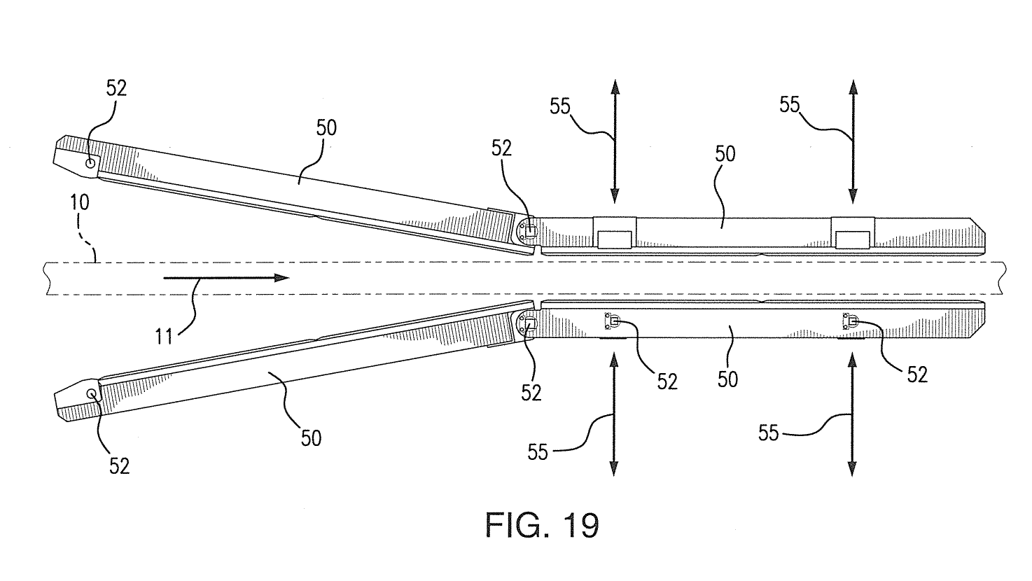

FIG. 19 shows guides 50 that can be used to direct or guide material 10, which can be a metal slab and/or any other suitable stock or material, as material 10 passes through milling apparatus 15, according to some embodiments of this invention. FIG. 19 shows material 10 passing in a direction of arrow 11 but material 10 can pass in any other suitable direction with respect to milling apparatus 15.

In some embodiments according to this invention, at least one guide 50 can be moved to accommodate for differently sized materials 10. For example, guides 50 as shown in FIG. 19 can be moved with respect to each other, closer together and/or further apart from each other, in order to accommodate for materials 10 having different widths and/or heights.

FIG. 19 shows movers 55 moving guides 50 in any suitable direction, such as shown by the arrows in FIG. 19. In different embodiments of this invention, mover 55 can be any suitable mechanical, electrical and/or magnetic device or other device capable of moving guide 50. In some embodiments of this invention, mover 55 can be pivotally attached with respect to guide 50 and in other embodiments of this invention mover 55 can be non-pivotally attached with respect to guide 50. In some embodiments of this invention, any mover 55 can be programmed to automatically move guide 50.

In some embodiments of this invention, each pivot 52 allows guide 50 to be pivotally moved with respect to the ground and/or milling apparatus 15. Any suitable pivot device, element and/or structure can be used to allow guide 50 to pivot with respect to each other, the ground and/or milling apparatus 15. In some embodiments of this invention, mover 55 is pivotally attached with respect to guide 50.

According to some embodiments of this invention, guide 50 can have any suitable cross sectional shape and/or any suitable outer shape. In some embodiments of this invention, guide 50 can be made from any suitable material, particularly that can withstand the relatively high temperatures and forces generated by material 10 moving direction 11 through milling apparatus 15.

In some embodiments of this invention, guides 50 are positioned and/or laid out with respect to each other to allow material 10 to pass through milling apparatus 15.

According to some embodiments of this invention, milling apparatus 15 can be operated by movably mounting movable curtain 150 within the housing formed by hood 25 and/or any other suitable structure. In some embodiments of this invention, cartridge 80 is used to move movable curtain 150.

While in the foregoing specification this invention has been described in relation to certain preferred embodiments, and many details are set forth for purposes of illustration, it will be apparent to those skilled in the art that this invention is susceptible to additional embodiments and that certain of the details described in this specification and in the claims can be varied considerably without departing from the basic principles of this invention.

What is claimed is:

1. In a milling apparatus having a hood forming a housing and a metal curtain movably mounted within the housing, the metal curtain comprising a cartridge attached to the metal curtain, and the cartridge movably mounted on a support mounted with respect to the housing.

2. In the milling apparatus according to claim 1, wherein the cartridge comprises a tubular member slidably mounted with respect to the support.

3. In the milling apparatus according to claim 1, further comprising a lock engageable to secure the cartridge with respect to the support.

4. In the milling apparatus according to claim 1, wherein a movable guide contacts a material passing through the milling apparatus.

5. In the milling apparatus according to claim 1, further comprising a plate attached with respect to the housing.

6. In the milling apparatus according to claim 5, wherein the plate is attached to and at least partially covers a base.

7. In the milling apparatus according to claim 1, wherein the metal curtain is movable between different positions corresponding to different materials passing through the hood.

8. A milling apparatus having a housing forming a furnace space, the milling apparatus comprising: a movable metal curtain housed within the furnace space and movable between different positions, a cartridge attached to the metal curtain, and the cartridge movable with respect to a support attached with respect to the housing.

9. The milling apparatus according to claim 8, wherein the cartridge is slidably mounted with respect to the support.

10. The milling apparatus according to claim 8, wherein a lock engageably secures the cartridge with respect to the support.

11. The milling apparatus according to claim 8, wherein a movable guide contacts a material passing through the milling apparatus.

12. The milling apparatus according to claim 8, further comprising a plate attached with respect to the housing.

13. The milling apparatus according to claim 12, wherein the plate is attached to and at least partially covers a base.

14. The milling apparatus according to claim 8, wherein the metal curtain is movable between different positions corresponding to different materials passing through the milling apparatus.

15. A method for operating a milling apparatus having a hood structure, the method including:
movably mounting a metal curtain within a housing formed by the hood structure;
attaching a cartridge to the metal curtain; and
movably mounting the cartridge on a support mounted with respect to the housing.

16. The method according to claim 15, wherein the cartridge is slidably mounted with respect to the support.

17. The method according to claim 15, wherein engaging a lock secures the cartridge with respect to the support.

18. The method according to claim 15, wherein a plate is attached with respect to the housing.

19. The method according to claim 18, wherein the plate is attached to and at least partially covers a base.

20. The method according to claim 15, wherein a movable guide contacts a material passing through the milling apparatus.
